(19) United States
(12) Patent Application Publication
(10) Pub. No.: US 2026/0098595 A1
(43) Pub. Date: Apr. 9, 2026

(54) VALVE WITH COMBINED ROTATION STOP AND STEM BLOWOUT PREVENTION

(71) Applicant: BELIMO HOLDING AG, Hinwil (CH)

(72) Inventors: Michael BALESTRA, Ridgefield, CT (US); Daniel OBUCHOWSKI, Brookfield, CT (US)

(73) Assignee: BELIMO HOLDING AG, Hinwil (CH)

(21) Appl. No.: 18/905,545

(22) Filed: Oct. 3, 2024

(51) Int. Cl. F16K 41/16; F16K 1/50

(52) U.S. Cl. CPC F16K 41/16; F16K 1/50

(57) ABSTRACT

The valve includes a valve body forming a valve opening, an actuator flange, a valve stem configured to be disposed through the actuator flange, and an end stop plate. The end stop plate is configured to interface with the valve stem such that rotations of the valve stem and the end stop plate around a rotation axis of the valve are coupled. The end stop plate is further configured to interface with the actuator flange such that a rotation of the end stop plate around the rotation axis is limited in at least one direction and, in at least a portion of the rotation of the end stop plate around the rotation axis, the end stop plate is prevented from translating along the rotation axis away from the valve opening. Thus, an interface between the end stop plate and the actuator flange performs multiple functions.

### FIELD

This disclosure is directed to fluid control valves (e.g., butterfly valves), such as those used in heating, ventilation, and air conditioning (HVAC) applications.

### BACKGROUND

Many valves control fluid flows (e.g., open, close, or somewhere there-between) via shafts (also called stems) connected to rotating assemblies (e.g., discs or balls). The shafts are rotated via actuators (e.g., handles, pneumatic or hydraulic actuators, or electric actuators), which causes the rotating assemblies to turn, thus controlling the flows.

The actuators can cause the rotating assemblies to move in ways which may not be optimal. For example, the actuators may cause the rotating assemblies to close with too much force, which can damage the valves and/or cause pre-mature wear. Furthermore, the shafts can break and be ejected from the valves towards the actuators causing a safety issue.

### SUMMARY

A valve is described herein. The valve includes a valve body forming a valve opening, an actuator flange, a valve stem configured to be disposed through the actuator flange, and an end stop plate. The end stop plate is configured to interface with the valve stem such that rotations of the valve stem and the end stop plate around a rotation axis of the valve are coupled. The end stop plate is further configured to interface with the actuator flange such that a rotation of the end stop plate around the rotation axis is limited in at least one direction and, in at least a portion of the rotation of the end stop plate around the rotation axis, the end stop plate is prevented from translating along the rotation axis away from the valve opening.

A method of assembling a valve is also described herein. The method includes arranging an end stop plate such that a cutout in the end stop plate is aligned with a tab of an actuator flange of the valve. The method also includes translating the end stop plate along a rotation axis of the valve towards a valve opening of the valve and into a recess of the actuator flange such that at least a portion of the end stop plate translates past the tab along the rotation axis. The method further includes rotating the end stop plate such that an end stop plate translation portion of the end stop plate is disposed underneath the tab.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates an example valve with combined rotation stop and stem blowout prevention.

FIG. 2A illustrates a first view of an example actuator flange that may be used in the example valve.

FIG. 2B illustrates a second view of the example actuator flange that may be used the example valve.

FIG. 3A illustrates a first view of an example end stop plate that may be used in the example valve.

FIG. 3B illustrates a second view of the example end stop plate that may be used in the example valve.

FIG. 4 illustrates an example valve stem that may be used in a valve with combined rotation stop and stem blowout prevention.

FIG. 5 illustrates an example assembly of the example valve.

FIG. 6 illustrates an assembled position of the example valve.

FIG. 7 illustrates an open position of the example valve.

FIG. 8 illustrates a closed position of the example valve.

FIG. 9 illustrates an assembly of another example valve with combined rotation stop and stem blowout prevention.

FIG. 10 illustrates a closed position of the other example valve.

FIG. 11 illustrates an assembly of a third example valve with combined rotation stop and stem blowout prevention.

FIG. 12 illustrates a closed position of the third example valve.

FIG. 13 illustrates an example combined valve stem/end stop plate that may be used in a valve with combined rotation stop and stem blowout prevention.

FIG. 14 illustrates an example method of assembling a valve with combined rotation stop and stem blowout prevention.

### DETAILED DESCRIPTION

### Overview

Actuators of rotating valves (e.g., butterfly or ball valves) can cause rotating assemblies of the valves to move in non-optimum ways. For example, the actuators may cause the rotating assemblies to close with too much force and/or rotate past an angle required for closing, which can damage the valves and/or cause pre-mature wear on the valves. Furthermore, valve stems connected to the actuators can break and be ejected from the valves causing damage and/or safety issues.

A valve is described herein. The valve includes a valve body forming a valve opening, an actuator flange, a valve stem configured to be disposed through the actuator flange, and an end stop plate. The end stop plate is configured to interface with the valve stem such that rotations of the valve stem and the end stop plate around a rotation axis of the valve are coupled. The end stop plate is further configured to interface with the actuator flange such that a rotation of the end stop plate around the rotation axis is limited in at least one direction and, in at least a portion of the rotation of the end stop plate around the rotation axis, the end stop plate is prevented from translating along the rotation axis away from the valve opening.

Thus, an interface between the end stop plate and the actuator flange performs multiple functions (e.g., a rotation hard-stop and stem blowout prevention). Doing so may enable higher safety while also reducing cost and complexity of the valve (e.g., by using fewer parts than conventional valves).

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

### Example Valve

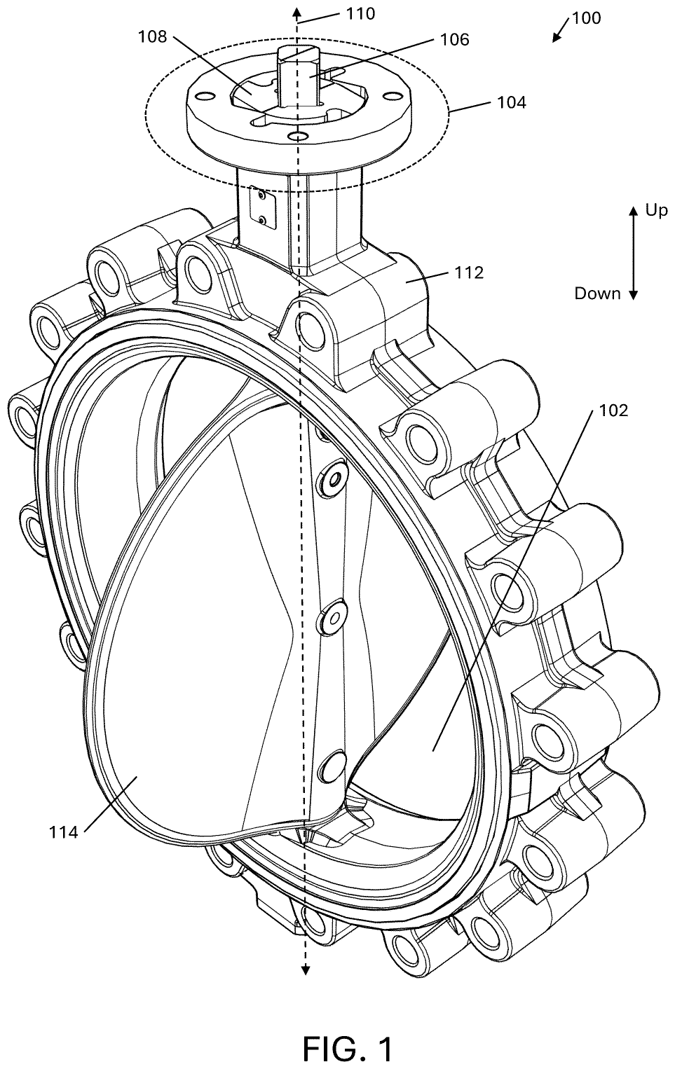

FIG. 1 illustrates an example of a valve 100 with combined rotation stop and stem blowout prevention. The valve 100 is configured to control flow of a fluid. The fluid may be a liquid (e.g., water, glycol mixtures, refrigerants, mineral oils, or other chemicals, mixtures, or emulsions with a fixed volume) or a gas (e.g., air or other substance with no fixed volume). Although the valve 100 is illustrated with one implementation of features/components, the features/components may be switched with any of the alternative embodiments discussed below without departing from the scope of this disclosure.

The valve 100 includes a valve body 112 that forms a valve opening 102. The valve body 112 may have mounting provisions (e.g., an array of holes) configured to mount the valve 100 in between pipe flanges. The valve opening 102 may be any size and/or configuration. For example, the valve opening 102 may be a generally round orifice with a size corresponding to a standard pipe size.

Disposed within the valve opening 102 is a disc 114. The disc 114 may be configured to rotate relative to the valve opening 102 to control fluid flow through the valve 100. Although a disc 114 is illustrated, the valve 100 may be a ball valve with a ball instead of the disc 114 without departing from the scope of this disclosure.

The valve body 112 may include an actuator flange 104 configured to couple with an actuator (e.g., handle, pneumatic or hydraulic actuator, or electric actuator). In some implementations, the actuator flange 104 may be formed separate from the valve body 112 and attached thereto.

Disposed through the actuator flange 104 and the valve body 112 is a valve stem 106. The valve stem 106 may extend through the valve opening 102 (as illustrated) or stop short (e.g., only extend to the valve opening 102). The disc 114 may be attached to the valve stem 106 such that rotations of the valve stem 106 and the disc 114 are coupled.

Within the actuator flange 104 and coupled with the valve stem 106, is an end stop plate 108. The end stop plate 108 may be recessed within the actuator flange 104 such that an actuator may be mounted without hitting the end stop plate 108. The end stop plate 108, the valve stem 106, and the disc 114 are all configured to be rotationally coupled such that they rotate about a rotation axis 110 of the valve in unison (e.g., as a rotating assembly of the valve 100).

### Example Actuator Flange

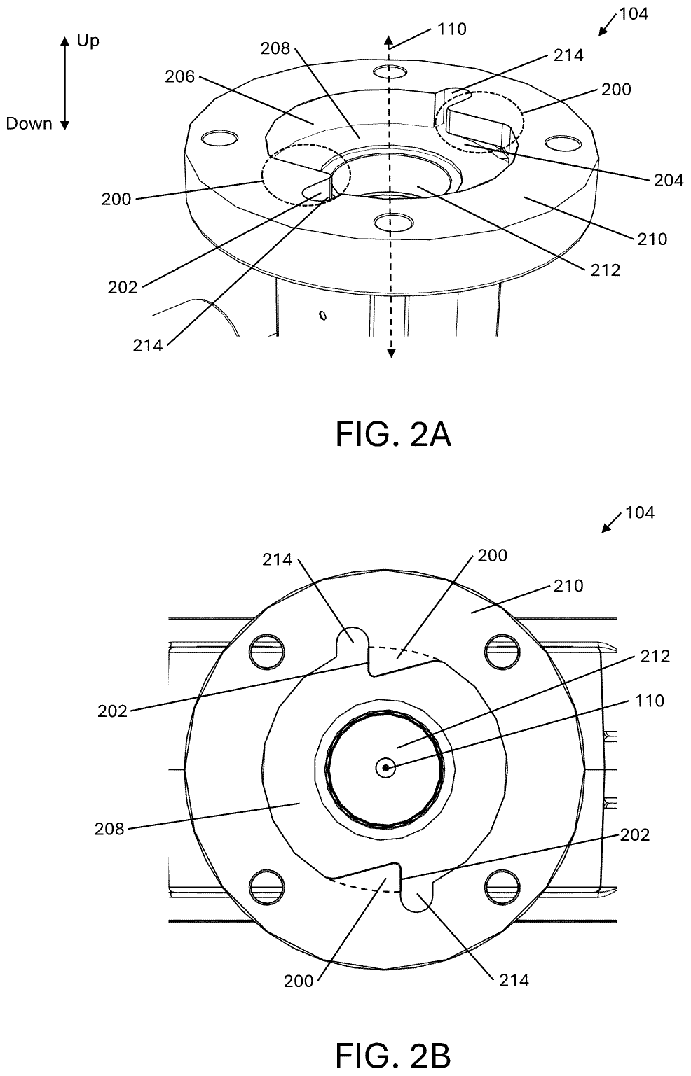

FIGS. 2A and 2B illustrate first and second views, respectively, of an example of the actuator flange 104. An up-down reference is illustrated for convention and should not be interpreted to be limiting.

The actuator flange 104 includes an actuator flange top surface 210. The actuator flange top surface 210 may be flat and may be configured to interface with an actuator (with or without an intermediate component such as a gasket). The actuator flange top surface 210 may have a round exterior shape (as illustrated) or may have another exterior shape.

A recess 206 may be formed within the actuator flange 104. The recess 206 may be configured to receive an end stop plate 108 (discussed below). The recess 206 may be generally round with a diameter that is at least slightly larger than radial extents (e.g., a diameter) of the end stop plate 108. Doing so may allow the end stop plate 108 to freely rotate within the recess 206. Otherwise, the end stop plate 108 may bind within the recess 206 while rotating. A depth of the recess 206 may be at least slightly larger than a height or thickness of the end stop plate 108. Doing so may enable the end stop plate 108 to be fully within the recess 206 with a margin of error. Otherwise, the end stop plate 108 may extend out of the recess 206 and/or interact with the actuator.

A recess surface 208 at the bottom of the recess 206 may be flat (as illustrated) or may have bends and/or curvature. At least at a wall of the recess 206, a depth may be formed between the actuator flange top surface 210 and the recess surface 208. As discussed above, the depth may be at least slightly greater than a height of the end stop plate 108.

Formed through the actuator flange 104 and in communication with the recess 206 is a valve stem hole 212. The valve stem hole 212 may be aligned with the rotation axis 110. Similarly, the recess 206 and/or the actuator flange top surface 210 may be aligned with the rotation axis 110. The valve stem hole 212 may have a diameter that corresponds to a diameter of the valve stem 106 and may extend from the recess surface 208 to the valve opening 102.

Extending into the recess 206 are one or more tabs 200. For example, two of the tabs 200 may be used for a valve that opens 90 degrees nominally. The tabs 200 may have a top surface that is flush with the actuator flange top surface 210. The tabs 200 are configured to interface with the end stop plate 108 to prevent the valve stem 106 from being ejected from the valve 100 and to limit a rotation of the valve stem 106 (and thus, the disc 114).

The tabs 200 may extend down into the recess 206. The tabs 200, however, may not contact the recess surface 208. In other words, undercuts 204 may be formed between the tabs 200 and the recess surface 208. The undercuts 204 are configured to allow a portion of the end stop plate 108 to extend underneath the tabs 200. Because the portion of the end stop plate 108 is underneath the tabs 200, and because the valve stem 106 may be configured to not translate past the end stop plate 108, the tabs 200 may enable stem blowout prevention.

To enable a rotation stop, the tabs 200 include tab rotation surfaces 202. The tab rotation surfaces 202 are configured to interface with a portion of the end stop plate 108 to prevent the end stop plate 108 from rotating past a certain angle. The certain angle may correspond to a closed state of the valve. Thus, the interface between the end stop plate 108 and the tab rotation surfaces 202 enables a hard rotation stop.

Other features may be included within the actuator flange 104. For example, actuator flange reliefs 214 may be included to enable easier, faster, and/or cheaper machining of the actuator flange 104 (e.g., to allow for tool paths). Similarly, other features may be added or removed to allow or ease manufacturing of the features described herein.

### Example End Stop Plate

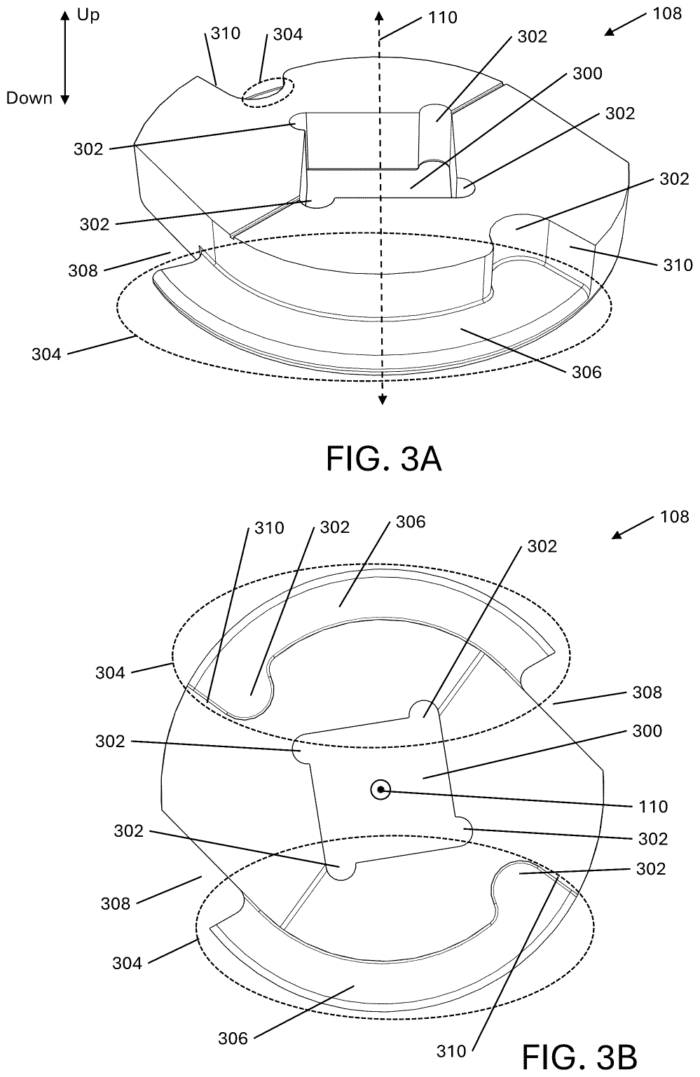

FIGS. 3A and 3B illustrate first and second views, respectively, of an example of the end stop plate 108. An up-down reference is illustrated for convention and should not be interpreted to be limiting.

The end stop plate 108 may be generally flat with two or more thicknesses or heights. The end stop plate 108 may also have a generally round shape as can be seen in FIG. 3B.

The end stop plate 108 includes one or more end stop plate translation portions 304 that are configured to extend underneath the tabs 200. The end stop plate translation portions 304 may have a height corresponding to the undercuts 204 (e.g., slightly less than a height of the undercuts 204 if the end stop plate translation portions 304 extend from a bottom surface of the end stop plate 108). Thus, the end stop plate 108 may have two heights: a first height corresponding to the end stop plate translation portions 304 and a second height corresponding to a general height of the end stop plate 108.

The end stop plate translation portions 304 include respective end stop plate translation surfaces 306 that are configured to interface with the tabs 200 (e.g., surfaces on undersides of the tabs 200) to enable blow-out prevention. The end stop plate translation surfaces 306 may have angular durations around the rotation axis 110 that are greater than 90 degrees (to enable blowout prevention for all operating angles of the valve 100). In other words, the end stop plate translation surfaces 306 may wrap around at least a quarter of a circumference of the end stop plate 108.

The end stop plate 108 also includes end stop plate rotation surfaces 310. The end stop plate rotation surfaces 310 are configured to interface with the tab rotation surfaces 202 to prevent the end stop plate 108 (and, thus, the valve 100) from closing past a certain point. The end stop plate rotation surfaces 310 may be orthogonal to the end stop plate translation surfaces 306 and may be connected to the end stop plate translation surfaces 306. Regardless of how they are configured, the end stop plate rotation surfaces 310 in conjunction with the tab rotation surfaces 202 enable a hard rotation stop of the valve 100.

The end stop plate 108 also includes cutouts 308. The cutouts 308 are configured to allow the end stop plate to translate at least partially past the tabs 200 and into the recess 206 in a certain relative rotation between the end stop plate 108 and the actuator flange 104.

To couple the end stop plate 108 with the valve stem 106, an engagement hole 300 may be formed within the end stop plate 108. The engagement hole 300 may be centered on the rotation axis 110 and may be shaped in any way to allow rotation coupling between the valve stem 106 and the end stop plate 108. For example, the square hole illustrated couples the rotation. Similarly, other shapes (triangle, hexagon, D-shape) may be used to allow rotation coupling. An angle between the engagement hole 300 and the end stop plate rotation surfaces 310 may correspond to a desired closing position/angle. It should be noted that the end stop plate 108 may be rotated 180 degrees around the valve stem 106 with similar effects.

Similar to the actuator flange 104, the end stop plate 108, depending upon manufacturing means of the end stop plate 108, may include any number of end stop plate reliefs 302. The end stop plate 108 may have more or less end stop plate reliefs 302 than illustrated and in different sizes and configurations without departing from the scope of this disclosure.

### Example Valve Stem

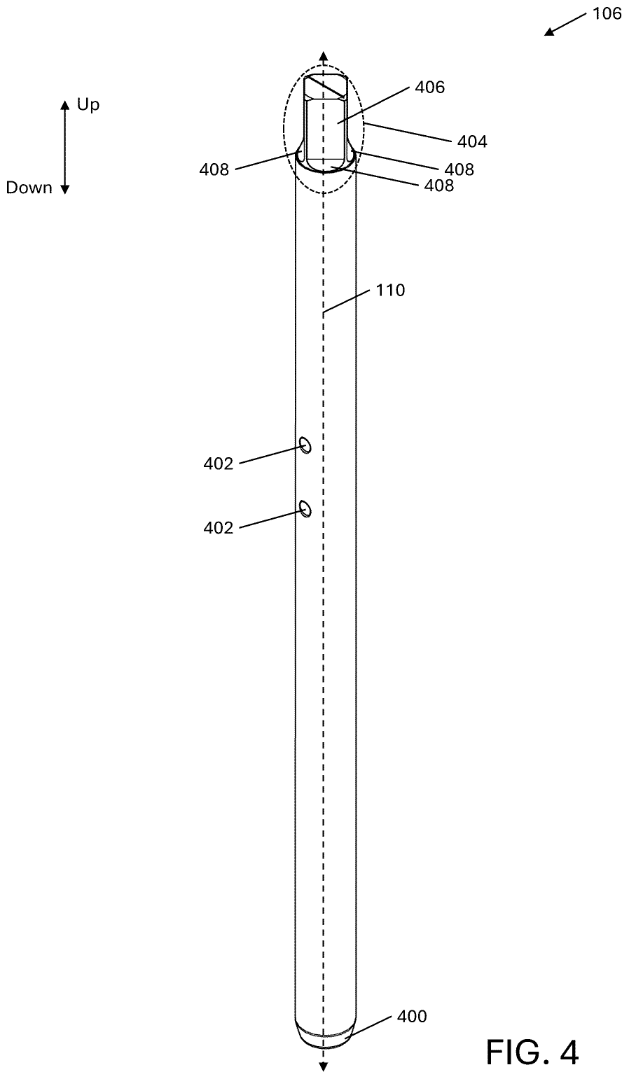

FIG. 4 illustrates an example of the valve stem 106 that may be used in a valve with combined rotation stop and stem blowout prevention. The valve stem 106 is generally cylindrical and is configured to rotate about the rotation axis 110. The valve stem 106 may have a length configured to extend from above the actuator flange 104 and through the valve opening 102.

A bottom of the valve stem 106 may include a chamfer 400 (or fillet) where the valve stem 106 interfaces with the valve body 112 at the bottom of the valve opening 102. The valve stem may also include valve mounting portions 402 that are configured to allow the disc 114 to attach to the valve stem 106.

A top of the valve stem 106 may include an engagement portion 404. The engagement portion 404 may be configured to extend through the end stop plate 108 and interface with an actuator. The engagement portion 404 may include one or more flat surfaces 406 and may have a cross-sectional area that is less than rest of the valve stem 106 (e.g., a largest cross-sectional dimension of the engagement portion 404 may be smaller than a largest diameter of the valve stem 106). A shape of the engagement portion 404 may correspond to the engagement hole 300 in the end stop plate 108. For example, if the engagement hole is square shaped, then the engagement portion 404 may also be square shaped (e.g., have four flat surfaces 406).

It should be noted that the engagement portion 404 may not be uniform in its length. For example, an interface with an actuator may be different than an interface with the engagement hole 300. Thus, a first portion of the engagement portion 404 may be configured to interface with the engagement hole 300 and a second portion may be configured to interface with an actuator. Furthermore, the engagement portion 404 may be configured to interface with an adapter disposed between the valve 100 and an actuator.

At the base of the engagement portion 404 may be one or more valve stem translation surfaces 408. The valve stem translation surfaces 408 are configured to abut against an area of the end stop plate 108 that surrounds the engagement hole 300. The valve stem translation surfaces 408 are configured to transfer a longitudinal load from the valve stem 106 (e.g., due to a failure of the valve stem 106) to the end stop plate 108. In some implementations, a snap ring or other device may alternatively or additionally be used to facilitate such a load transfer.

### Example Assembly and Operation

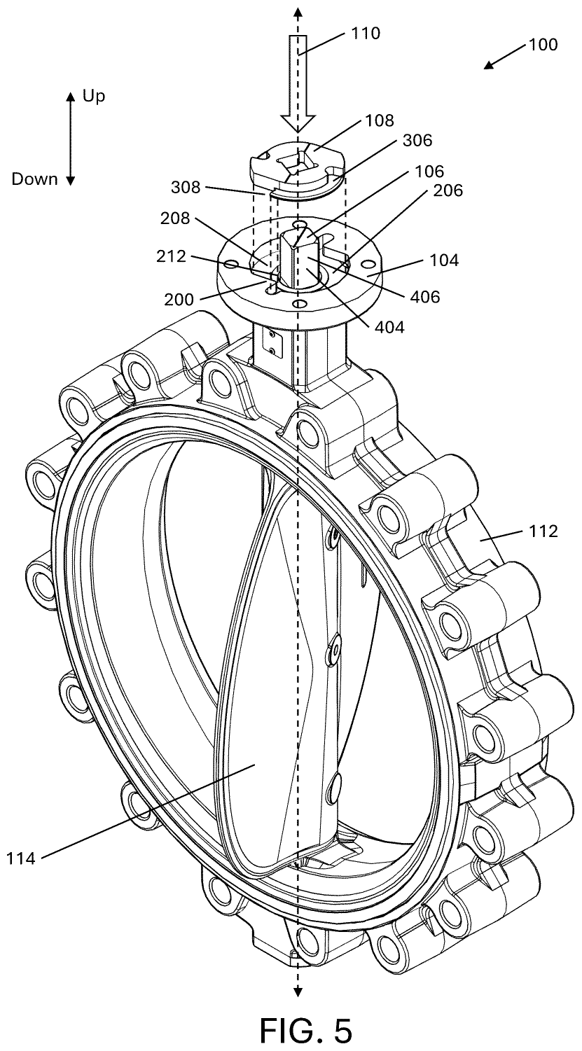

FIG. 5 illustrates an assembly of the valve 100. In the illustrated example, the valve stem 106 has been installed within the valve body 112 (e.g., inserted through the valve stem hole 212), the disc 114 has been attached to the valve stem 106, and the disc 114 has been opened to an assembly position (e.g., greater than 90 degrees from opening, such as 115 degrees).

The end stop plate 108 may be aligned with the valve stem 106 and slid over the engagement portion 404 such that the cutouts 308 are aligned with the tabs 200. As discussed above, the orientation of the end stop plate 108 may be the same 180 degrees of rotation around the rotation axis 110. In some implementations, there may only be a single way for the end stop plate 108 to slide over the engagement portion 404 (e.g., if the engagement portion has a single flat surface 406).

The end stop plate 108 may be slid down the engagement portion 404 until an underside of the end stop plate 108 reaches the recess surface 208 (or at least until the end stop plate translation surfaces 306 are underneath the tabs 200). When the end stop plate 108 is in the recess 206 and the disc 114 is in the assembly position (e.g., 115 degrees from closed), the valve 100 may be an assembled position.

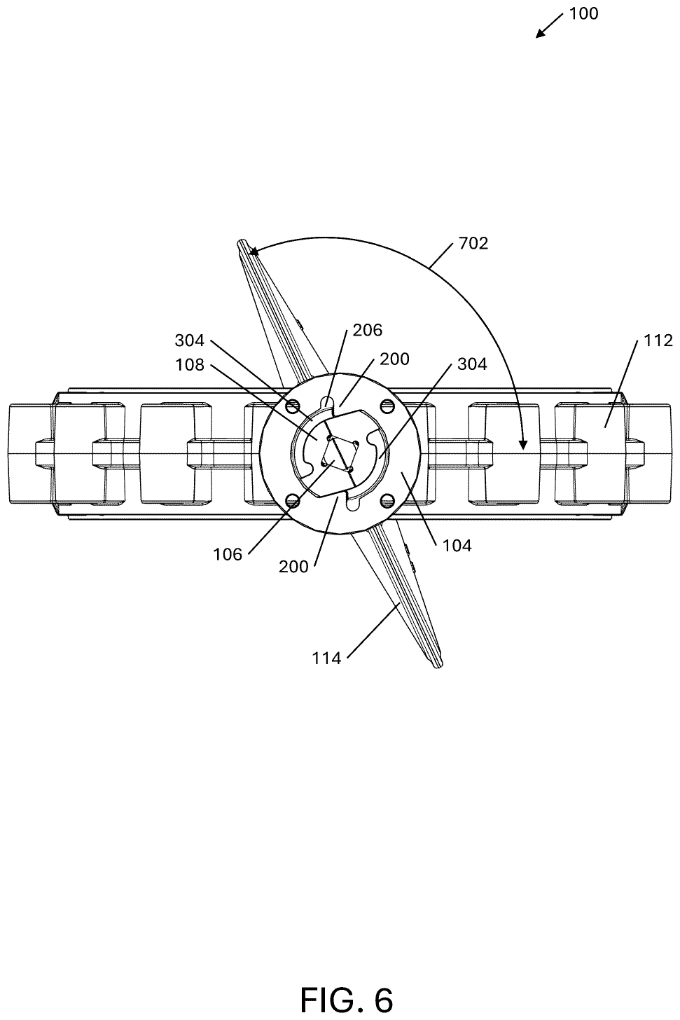

FIG. 6 illustrates the valve 100 in the assembled position. As discussed above, the disc 114 may be at an assembly angle 702 that is greater than an opening angle of the disc 114 (e.g., 115 degrees from parallel with the valve body 112 or a closed position of the disc 114). In the assembled position, the end stop plate 108 is free to translate out of the recess 206, as the end stop plate translation portions 304 are not within the undercuts 204 (e.g., underneath the tabs 200). Furthermore, it should be noted that, in the assembly position, the disc 114 and/or the valve stem 106 are rotated relative to their positions in the closed position further than their positions in the open position relative to the closed position.

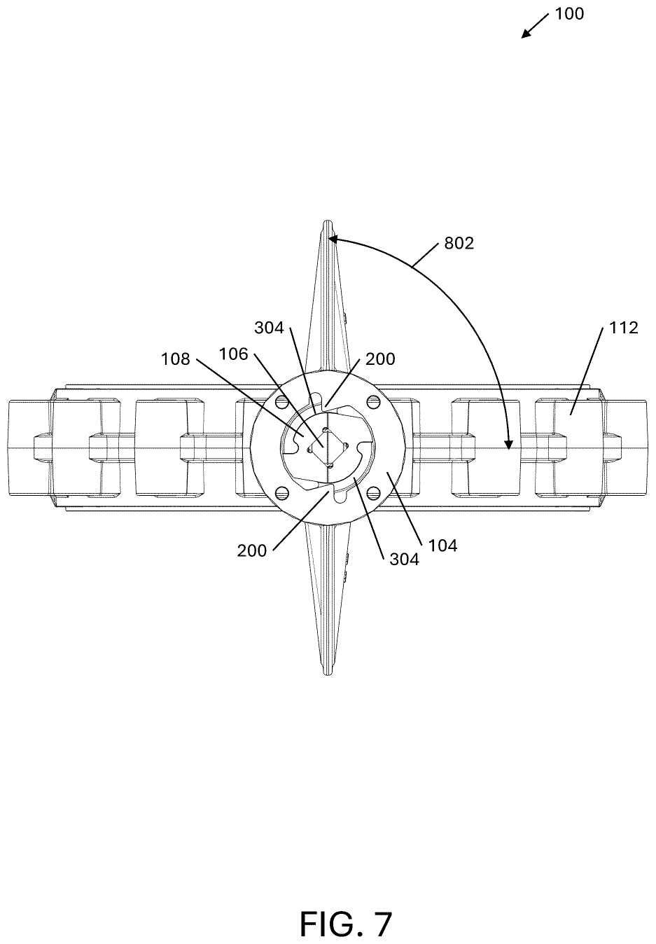

FIG. 7 illustrates the valve 100 in the open position. The open position may correspond to an open angle 802 that is less than the assembly angle 702 and configured for maximum flow of fluid through the valve 100 (e.g., 90 degrees from parallel with the valve body 112).

To get from the assembled position to the open position, the disc 114, the valve stem 106, and the end stop plate 108 may all be rotated (they are rotationally coupled about the rotation axis 110). In doing so, the end stop plate translation portions 304 may travel underneath the tabs 200, as long as the end stop plate 108 stays within the recess 206 during the rotation. Because the end stop plate translation portions 304 are underneath the tabs 200, blowout prevention is realized in the open position.

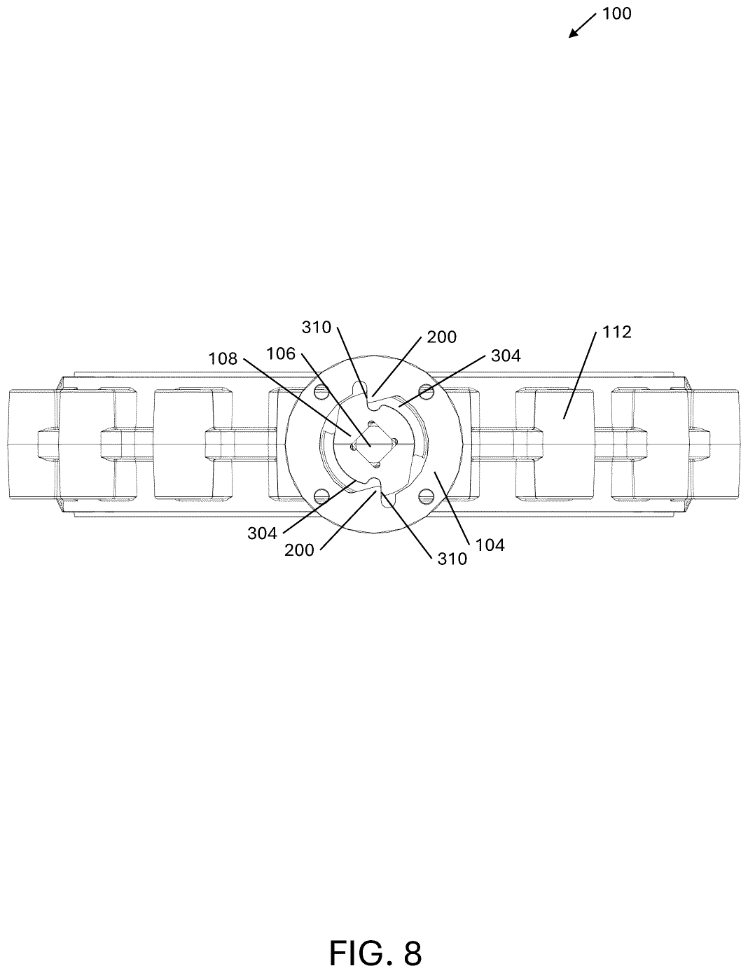

FIG. 8 illustrates the valve 100 in a closed position. The closed position may correspond to a configuration where the disc 114 (occluded by the valve body 112) abuts against and/or compresses a gasket within the valve opening 102 (also occluded by the valve body 112). As such, the disc 114 may not be parallel with the valve body 112 (e.g., it may be a few degrees relative to it). Accordingly, the valve 100 may be configured to open less than 90 degrees from the closed position to the open position.

In the closed position, the end stop plate translation portions 304 are still underneath the tabs 200 (e.g., within the undercuts 204 which are occluded by the tabs 200). It should be noted that the end stop plate translation portions 304 are underneath the tabs 200 throughout the operating angles of the valve (e.g., anywhere between the open position and the closed position). As such, the end stop plate 108 and, thus, the valve stem 106, are prevented from translating out of the valve 100 (e.g., during a valve stem failure).

In addition, in the closed position, the end stop plate rotation surfaces 310 are in contact with the tabs 200. Thus, the disc 114 is unable to rotate further clockwise in the illustrated example. Accordingly, the end stop plate 108 and the actuator flange 104 enable a hard rotation stop for the valve 100 without additional components.

### Alternative Implementations

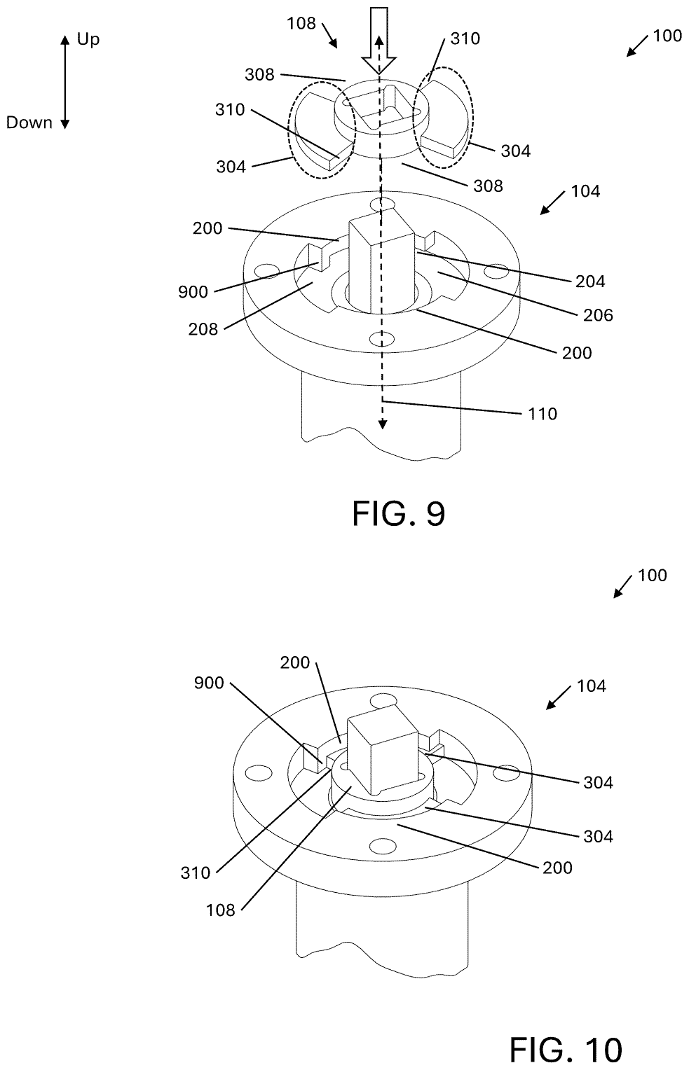

FIG. 9 illustrates an assembly of the valve 100 using another configuration of the end stop plate 108 and the actuator flange 104. Components/features that are not specifically mentioned may be similar to the other implementations described herein. In the alternative implementation, the end stop plate 108 includes the cutouts 308, the end stop plate translation portions 304, and the end stop plate rotation surfaces 310; however, they are configured differently. For example, the end stop plate rotation surfaces 310 are on ends of the end stop plate translation portions 304. Similarly, the actuator flange 104 includes the tabs 200 and the undercuts 204; however, they are configured differently.

To assemble the valve 100, the cutouts 308 allow the end stop plate 108 to be translated down the rotation axis 110, past the tabs 200, and into the recess 206. Although the end stop plate 108 is illustrated with multiple thicknesses/heights, it should be noted that the end stop plate 108, in this implementation, may be formed as a flat plate with a single thickness.

Additionally, in this implementation, the actuator flange 104 has actuator flange rotation portions 900 that extend between the tabs 200 and the recess surface 208. In other words, the undercuts 204 do not extend underneath an entirety of the tabs 200. A machining operation may form the undercuts 204 from a solid portion where the tabs 200 extended to the recess surface 208. Other manufacturing means may be used to achieve similar structures.

FIG. 10 illustrates the valve 100 with the end stop plate 108 and the actuator flange 104 from FIG. 9 in the closed position. In the closed position, the end stop plate rotation surfaces 310 are in contact with the actuator flange rotation portions 900. Accordingly, a hard rotation stop may be realized.

Similar to the previously described implementation, the end stop plate translation portions 304 are underneath the tabs 200 throughout at least 90 degrees of rotation from the closed position (e.g., to the open position). Accordingly, blowout prevention may be realized for the operating angles of the valve.

It should be noted that the angular durations of the end stop plate translation portions 304 may be greatly reduced in this implementation. For example, only one of the tabs 200 or the end stop plate translation portions 304 may need to have angular durations greater than 90 degrees. As long as portions of the end stop plate translation portions 304 are underneath portions of the tabs 200 throughout operating angles of the valve 100, blowout prevention may be realized for the operating angles of the valve 100.

Furthermore, in some implementations, the actuator flange rotation portions 900 may be replaced with other rotation stops. For example, if the actuator flange rotation portions 900 are not used, fasteners, pins, or other structures may be formed within the recess 206 to limit the rotation of the end stop plate 108. Yet further, the other rotation stops may be movably mounted to the actuator flange 104, enabling an adjustment of the hard rotation stop.

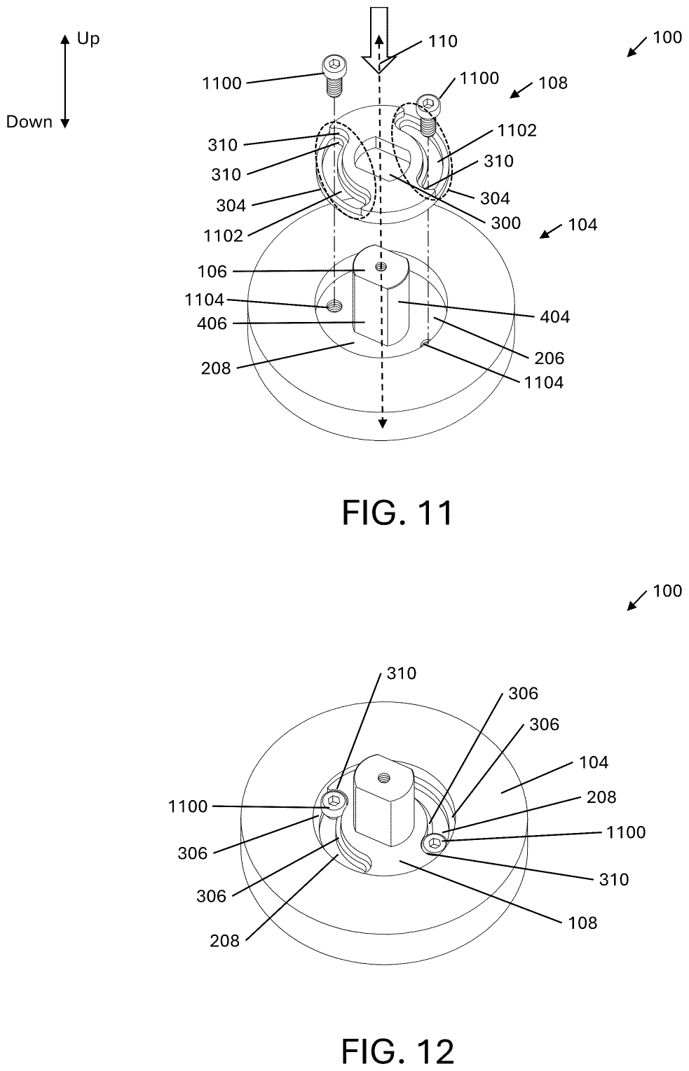

FIG. 11 illustrates an assembly of the valve 100 using yet another example configuration of the end stop plate 108 and the actuator flange 104. The actuator flange 104 does not include the tabs 200 nor the undercuts 204. Instead, the recess 206 may be a cylindrical bore formed or machined into the actuator flange 104.

The end stop plate 108 does not include the cutouts 308 but includes the end stop plate translation portions 304 and the end stop plate rotation surfaces 310; however, they are configured differently. For example, the end stop plate 108 may have a round perimeter, and the end stop plate translation portions 304 have curved slots 1102 formed therethrough. The curved slots 1102 may be configured to allow rotation of the end stop plate 108 around one or more fasteners 1100. In some implementations, the end stop plate translation portions 304 may not be recessed. In other words, the end stop plate 108 may be a flat plate with the curved slots formed therethrough. In such cases the end stop plate translation surfaces 306 may be included within/be the same as a top surface of the end stop plate 108.

One end of the curved slots 1102 or a wall forming an end of the end stop plate translation portions 304 may form the end stop plate rotation surfaces 310. The end stop plate rotation surfaces 310 may be configured to interface with heads of the fasteners 1100 (e.g., if the end stop plate rotation surfaces 310 are not in the slots) and/or with bodies of the fasteners 1100 (e.g., if the end stop plate rotation surfaces are within the curved slots 1102).

To assemble the valve 100, the end stop plate 108 is translated down the rotation axis 110, over the engagement portion 404 and into the recess 206. Different from the above, however, is that valve stem 106 may be in any configuration between open and closed positions (even slightly beyond open position). Furthermore, the engagement portion 404 is a round shaft with two flat surfaces 406 that are 180 degrees apart (e.g., instead of four flat surfaces 406 that are 90 degrees apart). Accordingly, the engagement hole 300 in the end stop plate 108 is shaped differently to accommodate the different configuration of the engagement portion 404.

The fasteners 1100 may then be disposed through the curved slots 1102 and attached to the recess surface 208 (e.g., via fastener mounting portions 1104 formed within the recess surface 208). The fastener mounting portions 1104 may have defined depths that ensure that the fasteners 1100 do not clamp down on the end stop plate 108. In some implementations, the fasteners 1100 may have shoulders to ensure that the end stop plate 108 is free to rotate underneath them.

In this implementation, the end stop plate 108 may be configured with two sets of end stop plate rotation surfaces 310. For example, one end of the curved slots 1102 may correspond to a hard stop for the closed position and another end of the curved slots 1102 may correspond to a hard stop for the open position. There may be no assembly position in this implementation as the valve 100 may be assembled anywhere between the open and closed positions (and even outside of them).

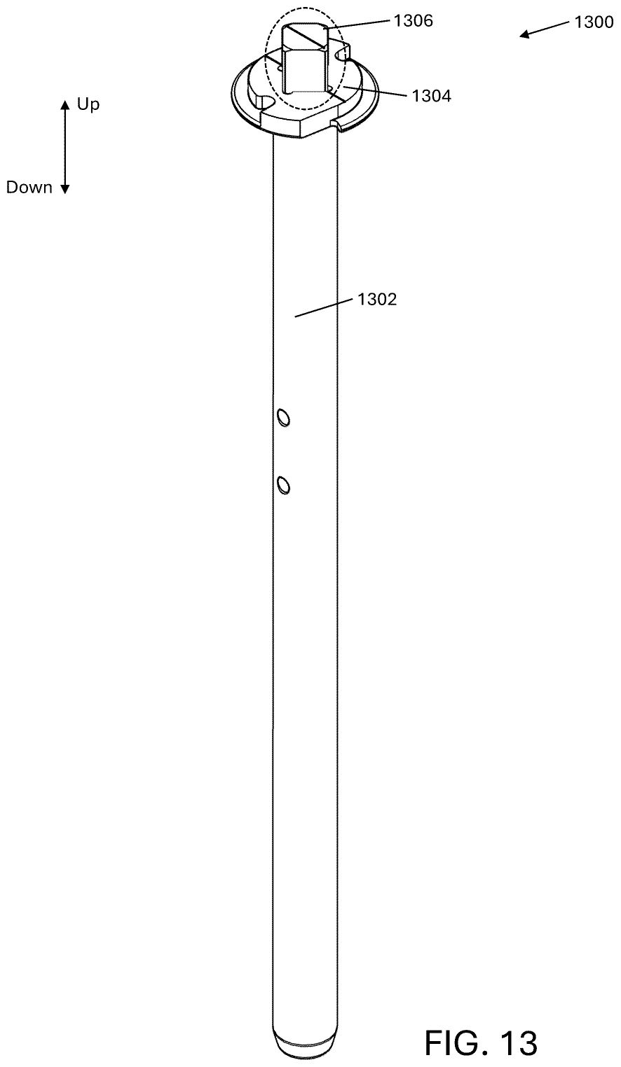

FIG. 12 illustrates the valve 100 with the end stop plate 108 and the actuator flange 104 from FIG. 11 in the closed position. The end stop plate rotation surfaces 310 are in contact with the fasteners 1100. Accordingly, a hard rotation stop may be realized.

Additionally, the end stop plate translation surfaces 306 are underneath heads of the fasteners 1100, which are secured to the actuator flange 104. Accordingly, blowout prevention may be realized.

FIG. 13 illustrates an example of a combined valve stem/end stop plate 1300 using features of the end stop plate 108 and the valve stem 106. The combined valve stem/end stop plate 1300 is similar to the end stop plate 108 being placed over the engagement portion 404 of the valve stem 106. Although the illustrated example shows features from a single implementation of the end stop plate 108 and the valve stem 106, features of any of the implementations of the end stop plate 108 and/or the valve stem 106 above may be used in the combined valve stem/end stop plate 1300.

Instead of being two components, however, the combined valve stem/end stop plate 1300 is a single component or structure. The combined valve stem/end stop plate 1300 includes a valve stem portion 1302, an end stop portion 1304, and an actuator engagement portion 1306. The valve stem portion 1302 and the actuator engagement portion 1306 may include similar features to the valve stem 106. The end stop portion 1304 may include similar features to the end stop plate 108. Those features (e.g., translation portions/surfaces, rotation portions/surfaces, cutouts) will not be repeated here.

The combined valve stem/end stop plate 1300 may be formed as a single structure (e.g., cast, injected molded, printed, and/or machined) or may be assembled as two structures that are combined (e.g., the end stop portion 1304 may be press fit, welded, and/or mechanically fastened to the valve stem portion 1302). By using a single component, the design of the valve 100 may be further simplified.

### Example Method

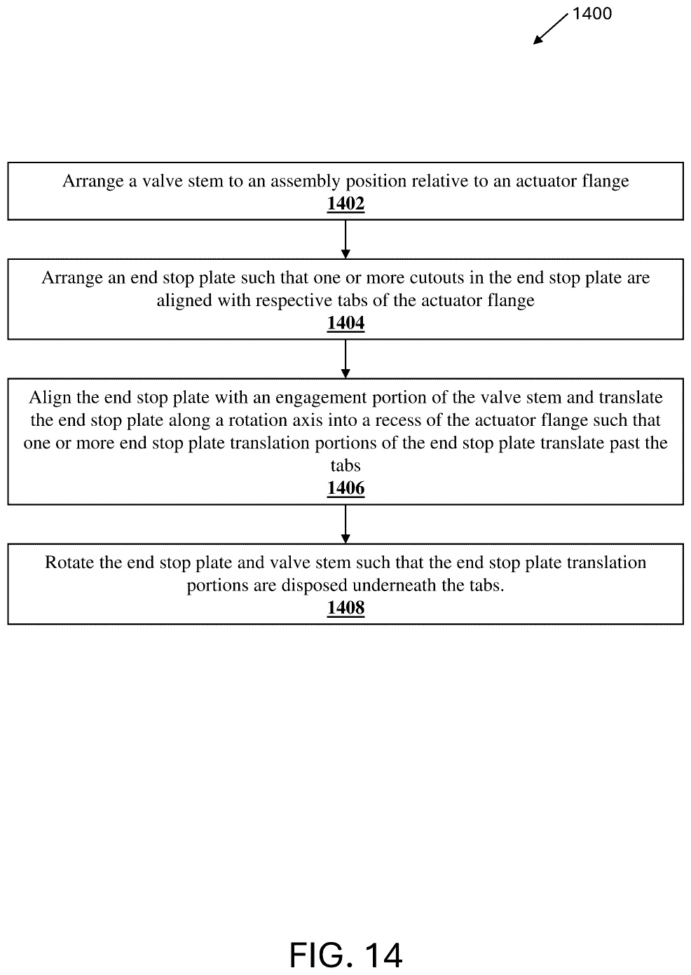

FIG. 14 illustrates a method 1400 of assembling the valve 100. Steps of the method 1400 may be rearranged, split, or combined without departing from the scope of this disclosure. Furthermore, it should be noted that other methods of assembling the valve 100 may be used without departing from the scope of this disclosure.

At 1402, a valve stem is arranged to an assembly position relative to an actuator flange. For example, the valve stem 106 may be arranged relative to the actuator flange 104/valve body 112 to that of the assembly position of FIGS. 5 and 9. The arrangement of the valve stem 106 may correspond to a relative rotation around the rotation axis 110 from that of the closed position of FIG. 8 that is greater than that of the open position of FIG. 7.

At 1404, an end stop plate is arranged such that one or more cutouts in the end stop plate are aligned with respective tabs of the actuator flange. For example, the end stop plate 108 may be arranged such that the cutouts 308 are aligned with the tabs 200.

At 1406, the end stop plate is aligned with an engagement portion of the valve stem and translated along a rotation axis into a recess of the actuator flange such that one or more end stop plate translation portions of the end stop plate translate past the tabs. For example, the end stop plate 108 may be aligned with the engagement portion 404 and may be translated along the rotation axis 110 into the recess 206 such that the end stop plate translation portions 304 translate past the tabs 200.

At 1408, the end stop plate and valve stem are rotated such that the end stop plate translation portions are disposed underneath the tabs. For example, the end stop plate 108 and valve stem 106 may be rotated to the open position, the closed position, or anywhere in between. Anywhere within those positions, the end stop plate translation portions 304 are disposed within the undercuts 204 (e.g., underneath the tabs 200). The valve 100 may be rotated to the closed position to achieve a compact form factor for shipping, transport, and/or installation.

### EXAMPLES

Example 1: A valve comprising: an actuator flange forming a recess; a valve stem disposed through the recess of the actuator flange; and an end stop plate: disposed within the recess of the actuator flange; coupled to the valve stem such that rotations of the valve stem and the end stop plate around a rotation axis of the valve are coupled; and configured to interface with the actuator flange such that: a rotation of the end stop plate around the rotation axis is limited in at least one direction; and in at least a portion of the rotation of the end stop plate around the rotation axis, the end stop plate is prevented from translating out of the recess.

Example 2: The valve of example 1, wherein the actuator flange comprises one or more tabs configured to interface with the end stop plate to prevent the end stop plate from translating out of the recess.

Example 3: The valve of example 2, wherein the actuator flange comprises one or more actuator flange rotation portions configured to interface with the end stop plate to limit the rotation of the end stop plate in the at least one direction.

Example 4: The valve of example 3, wherein the end stop plate is a flat plate with a single thickness.

Example 5: The valve of example 2, wherein the tabs are configured to interface with the end stop plate to limit the rotation of the end stop plate in the at least one direction.

Example 6: The valve of example 5, wherein the end stop plate comprises: one or more rotation surfaces configured to interface with the tabs to limit the rotation of the end stop plate in the at least one direction; and one or more end stop plate translation surfaces configured to interface with the tabs to prevent the end stop plate from translating out of the recess in the portion of the rotation.

Example 7: The valve of example 6, wherein the end stop plate rotation surfaces are orthogonal to the end stop plate translation surfaces.

Example 8: The valve of example 6 or 7, wherein the end stop plate translation surfaces have angular durations of at least 90 degrees relative to the rotation axis.

Example 9: The valve of example 6, 7, or 8, wherein the actuator flange forms one or more undercuts beneath the tabs configured to accommodate one or more end stop plate translation portions that comprise the end stop plate translation surfaces.

Example 10: The valve of any preceding example, wherein the end stop plate comprises one or more cutouts configured to allow the end stop plate to translate at least partially past the tabs when the end stop plate is not within the portion of the rotation.

Example 11: The valve of any preceding example, wherein the valve is configurable to: a closed position; an open position; and an assembly position where the valve stem and the end stop plate are rotated relative to their positions in the closed position further than their positions in the open position relative to the closed position.

Example 12: The valve of example 11, wherein: the end stop plate and the actuator flange are configured to prevent the end stop plate from translating out of the recess of the actuator flange in the closed position and in the open position; and the end stop plate and the actuator flange are configured to allow the end stop plate to translate out of the recess of the actuator flange in the assembly position.

Example 13: The valve of example 11 or 12, wherein the valve stem and the end stop plate in the assembly position are rotated at least 100 degrees relative their positions in the closed position.

Example 14: The valve of any preceding example, wherein: the valve comprises a valve body that forms a valve opening; the valve body comprises the actuator flange; and the valve stem extends through the valve opening.

Example 15: The valve of any preceding example, wherein the valve stem comprises an engagement portion configured to interface with: an engagement hole of the end stop plate and an actuator for the valve.

Example 16: The valve of example 15, wherein the engagement portion has one or more valve stem translation surfaces configured to transfer a force on the valve stem along the rotation axis to the end stop plate.

Example 17: The valve of any preceding example, wherein: the valve comprises a valve body that forms a valve opening; the actuator flange comprises an actuator flange top surface; the recess of the actuator flange extends from the actuator flange top surface towards the valve opening; a valve stem hole communicates with the recess and the valve opening; and the valve stem is disposed through the valve stem hole.

Example 18: The valve of any preceding example, wherein the valve stem and the end stop plate are formed as a single structure.

Example 19: A method of assembling a valve, the method comprising: arranging a valve stem to an assembly position relative to an actuator flange; arranging an end stop plate such that one or more cutouts in the end stop plate are aligned with respective tabs of the actuator flange; aligning the end stop plate with an engagement portion of the valve stem and translating the end stop plate along a rotation axis of the valve into a recess of the actuator flange such that one or more end stop plate translation portions of the end stop plate translate past the tabs; and rotating the end stop plate and valve stem such that the end stop plate translation portions are disposed underneath the tabs.

Example 20: A valve comprising: an actuator flange forming a recess; a valve stem disposed through the recess of the actuator flange; and an end stop plate: disposed within the recess of the actuator flange; coupled to the valve stem such that rotations of the valve stem and the end stop plate around a rotation axis of the valve are coupled; and configured to interface with fasteners disposed within the recess such that: the end stop plate is prevented from translating out of the recess; the end stop plate can rotate around the rotation axis; and a rotation of the end stop plate around the rotation axis is limited in at least one direction.

Example 21: The valve of example 20, wherein the end stop plate is a flat plate with a single thickness.

Example 22: The valve of example 20 or 21, wherein the end stop plate comprises: one or more rotation surfaces configured to interface with the fasteners to limit the rotation of the end stop plate in the at least one direction; and one or more end stop plate translation surfaces configured to interface with the fasteners to prevent the end stop plate from translating out of the recess.

Example 23: The valve of example 22, wherein the end stop plate rotation surfaces are orthogonal to the end stop plate translation surfaces.

Example 24: The valve of example 22 or 23, wherein the end stop plate translation surfaces have angular durations of at least 90 degrees relative to the rotation axis.

Example 25: The valve of any of examples 20-24, wherein: the valve comprises a valve body that forms a valve opening; the valve body comprises the actuator flange; and the valve stem extends through the valve opening.

Example 26: The valve of any of examples 20-25, wherein the valve stem comprises an engagement portion configured to interface with: an engagement hole of the end stop plate and an actuator for the valve.

Example 27: The valve of example 26, wherein the engagement portion has one or more valve stem translation surfaces configured to transfer a force on the valve stem along the rotation axis to the end stop plate.

Example 28: The valve of any of examples 20-27, wherein: the valve comprises a valve body that forms a valve opening; the actuator flange comprises an actuator flange top surface; the recess of the actuator flange extends from the actuator flange top surface towards the valve opening; a valve stem hole communicates with the recess and the valve opening; and the valve stem is disposed through the valve stem hole.

Example 29: The valve of any of examples 20-28, wherein the valve stem and the end stop plate are formed as a single structure.

Example 30: An end stop plate configured to: be disposed within a recess of an actuator flange of a valve body of a valve; couple with a valve stem of the valve such that rotations of the valve stem and the end stop plate around a rotation axis of the valve are coupled; and interface with the actuator flange such that: a rotation of the end stop plate around the rotation axis is limited in at least one direction; and in at least a portion of the rotation of the end stop plate around the rotation axis, the end stop plate is prevented from translating out of the recess.

Example 31: The end stop plate of example 30, wherein the end stop plate is a flat plate with a single thickness.

Example 32: The end stop plate of example 30 or 31, wherein the end stop plate comprises: one or more rotation surfaces configured to interface with tabs of the actuator flange to limit the rotation of the end stop plate in the at least one direction; and one or more end stop plate translation surfaces configured to interface with the tabs to prevent the end stop plate from translating out of the recess in the portion of the rotation.

Example 33: The end stop plate of example 32, wherein the end stop plate rotation surfaces are orthogonal to the end stop plate translation surfaces.

Example 34: The end stop plate of example 32 or 33, wherein the end stop plate translation surfaces have angular durations of at least 90 degrees relative to the rotation axis.

Example 35: The end stop plate of any of examples 30-34, wherein the end stop plate comprises one or more cutouts configured to allow the end stop plate to translate at least partially past tabs of the actuator flange when the end stop plate is not within the portion of the rotation.

Example 36: The end stop plate of any of examples 30-34, wherein the end stop plate comprises one or more curved slots formed therein, the curved slots configured to house respective fasteners secured to the actuator flange.

### Conclusion

The terminology used herein is for the purpose of describing particular embodiments only and is not intended to be limiting of this disclosure. As used herein, the singular forms “a,” “an,” and “the” are intended to include the plural forms as well, unless the context clearly indicates otherwise. It will be further understood that the terms “includes,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms up, upper, down, lower, above, below, left, right, forward, rearward, and the like are intended to be understood in the context of the representations described and illustrated above so that a wearable device may have such an orientation in reference to the frame or to various elements as supported by the frame or as illustrated in the drawing figures.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description but is not intended to be exhaustive or limited to this disclosure in the form disclosed. Many modifications and variations will be apparent to those of ordinary skill in the art without departing from the scope and spirit of this disclosure. The various embodiments were chosen and described in order to best explain the principles of this disclosure and the practical application, and to enable others of ordinary skill in the art to understand this disclosure for various embodiments with various modifications as are suited to the particular use contemplated.

What is claimed is:

1. A valve comprising:
an actuator flange forming a recess;
a valve stem disposed through the recess of the actuator flange; and
an end stop plate:
disposed within the recess of the actuator flange;
coupled to the valve stem such that rotations of the valve stem and the end stop plate around a rotation axis of the valve are coupled; and
configured to interface with the actuator flange such that:
a rotation of the end stop plate around the rotation axis is limited in at least one direction; and
in at least a portion of the rotation of the end stop plate around the rotation axis, the end stop plate is prevented from translating out of the recess.

2. The valve of claim 1, wherein the actuator flange comprises one or more tabs configured to interface with the end stop plate to prevent the end stop plate from translating out of the recess.

3. The valve of claim 2, wherein the actuator flange comprises one or more actuator flange rotation portions configured to interface with the end stop plate to limit the rotation of the end stop plate in the at least one direction.

4. The valve of claim 3, wherein the end stop plate is a flat plate with a single thickness.

5. The valve of claim 2, wherein the tabs are configured to interface with the end stop plate to limit the rotation of the end stop plate in the at least one direction.

6. The valve of claim 5, wherein the end stop plate comprises:
one or more rotation surfaces configured to interface with the tabs to limit the rotation of the end stop plate in the at least one direction; and
one or more end stop plate translation surfaces configured to interface with the tabs to prevent the end stop plate from translating out of the recess in the portion of the rotation.

7. The valve of claim 6, wherein the end stop plate rotation surfaces are orthogonal to the end stop plate translation surfaces.

8. The valve of claim 6, wherein the end stop plate translation surfaces have angular durations of at least 90 degrees relative to the rotation axis.

9. The valve of claim 6, wherein the actuator flange forms one or more undercuts beneath the tabs configured to accommodate one or more end stop plate translation portions that comprise the end stop plate translation surfaces.

10. The valve of claim 2, wherein the end stop plate comprises one or more cutouts configured to allow the end stop plate to translate at least partially past the tabs when the end stop plate is not within the portion of the rotation.

11. The valve of claim 1, wherein the valve is configurable to:
a closed position;
an open position; and
an assembly position where the valve stem and the end stop plate are rotated relative to their positions in the closed position further than their positions in the open position relative to the closed position.

12. The valve of claim 11, wherein:
the end stop plate and the actuator flange are configured to prevent the end stop plate from translating out of the recess of the actuator flange in the closed position and in the open position; and
the end stop plate and the actuator flange are configured to allow the end stop plate to translate out of the recess of the actuator flange in the assembly position.

13. The valve of claim 11, wherein the valve stem and the end stop plate in the assembly position are rotated at least 100 degrees relative to their positions in the closed position.

14. The valve of claim 1, wherein:
the valve comprises a valve body that forms a valve opening;
the valve body comprises the actuator flange; and
the valve stem extends through the valve opening.

15. The valve of claim 1, wherein the valve stem comprises an engagement portion configured to interface with: an engagement hole of the end stop plate and an actuator for the valve.

16. The valve of claim 15, wherein the engagement portion has one or more valve stem translation surfaces configured to transfer a force on the valve stem along the rotation axis to the end stop plate.

17. The valve of claim 1, wherein:
the valve comprises a valve body that forms a valve opening;
the actuator flange comprises an actuator flange top surface;
the recess of the actuator flange extends from the actuator flange top surface towards the valve opening;
a valve stem hole communicates with the recess and the valve opening; and
the valve stem is disposed through the valve stem hole.

18. The valve of claim 1, wherein the valve stem and the end stop plate are formed as a single structure.

19. A method of assembling a valve, the method comprising:
arranging a valve stem to an assembly position relative to an actuator flange;
arranging an end stop plate such that one or more cutouts in the end stop plate are aligned with respective tabs of the actuator flange;
aligning the end stop plate with an engagement portion of the valve stem and translating the end stop plate along a rotation axis of the valve into a recess of the actuator flange such that one or more end stop plate translation portions of the end stop plate translate past the tabs; and
rotating the end stop plate and valve stem such that the end stop plate translation portions are disposed underneath the tabs.

20. A valve comprising:
an actuator flange forming a recess;
a valve stem disposed through the recess of the actuator flange; and
an end stop plate:
disposed within the recess of the actuator flange;
coupled to the valve stem such that rotations of the valve stem and the end stop plate around a rotation axis of the valve are coupled; and
configured to interface with fasteners disposed within the recess such that:
the end stop plate is prevented from translating out of the recess;
the end stop plate can rotate around the rotation axis; and
a rotation of the end stop plate around the rotation axis is limited in at least one direction.
